(19) United States
(12) Patent Application Publication
(10) Pub. No.: US 2010/0094716 A1
(43) Pub. Date: Apr. 15, 2010

(54) METHOD AND COMPUTER-READABLE STORAGE MEDIA TO DETERMINE AND ACCESS PROVISIONING SERVICES

(76) Inventors: Chandramouli GANESAN, Plano, TX (US); Sanjoy Mukherjee, Plano, TX (US); Sarowar G. Sikder, Carrollton, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/252,020

(22) Filed: Oct. 15, 2008

(51) Int. Cl. G06Q 30/00

(52) U.S. Cl. 705/26

(57) ABSTRACT

Determining and accessing provisioning services. At least some of the illustrative embodiments are methods comprising interacting (by a human) with a first computer system executing a provisioning program and thereby making a first request for a service catalog that indicates a plurality of services of the provisioning program, selecting a service from the service catalog and thereby making a first request for a schema that defines one or more actions associated with a selected service, selecting an action associated with the selected service, generating a first electronic form based on the schema, providing (by the human) at least some of the information requested in the first electronic form, and performing an action by the provisioning program on one or more provisioning end points based on the information in the first electronic form.

### BACKGROUND

Conducting business in the computer age invariably involves interactions with many different computer systems and application programs. For example, an employee of a company may access an electronic mail account on a mail server, the employee may have dedicated space on a network server for storing files, and the employee may have need to access and/or modify entries in a database on a database server. Each of the computer systems and/or programs the employee accesses are individually configured to allow access by the employee, and significant time can be expended by information technology professionals to configure each system each time a new employee begins work, an employee changes status within the company, or the employee leaves the company.

The task of configuring disparate systems for use, such as use by a new employee, is known as “provisioning.” Software tools exist to aid in provisioning, and as such are known in some cases as provisioning programs. Any discovery or improvement that makes more efficient accessing and/or using provisioning programs would be beneficial.

### BRIEF DESCRIPTION OF THE DRAWINGS

For a detailed description of exemplary embodiments, reference will now be made to the accompanying drawings in which:

FIG. 1 shows a provisioning system in accordance with at least some embodiments;

FIG. 2 shows, in graphical form, an XML document in accordance with at least some embodiments;

FIG. 3 shows illustrative interactions between the web application and the provisioning program;

FIG. 4 shows a method in accordance with at least some embodiments; and

FIG. 5 shows a computer system in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect electrical connection via other devices and connections.

“Provisioning program” shall mean an executable program (or set of executable programs) that automates the task of adding, modifying or deleting information held and used by provisioning end points to provide services to a client (e.g., electronic mail access programs, payroll system to pay employees, directory servers where a client may access/store data, database used by an employee in day-to-day operations).

“Schema” shall mean information as well as a set of rules to which an electronic document conforms if the document is to be considered valid under the schema. The schema itself may be an electronic document and may be coded in any suitable fashion (e.g., Service Provisioning Markup Language (SPML), Extensible Markup Language (XML)).

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

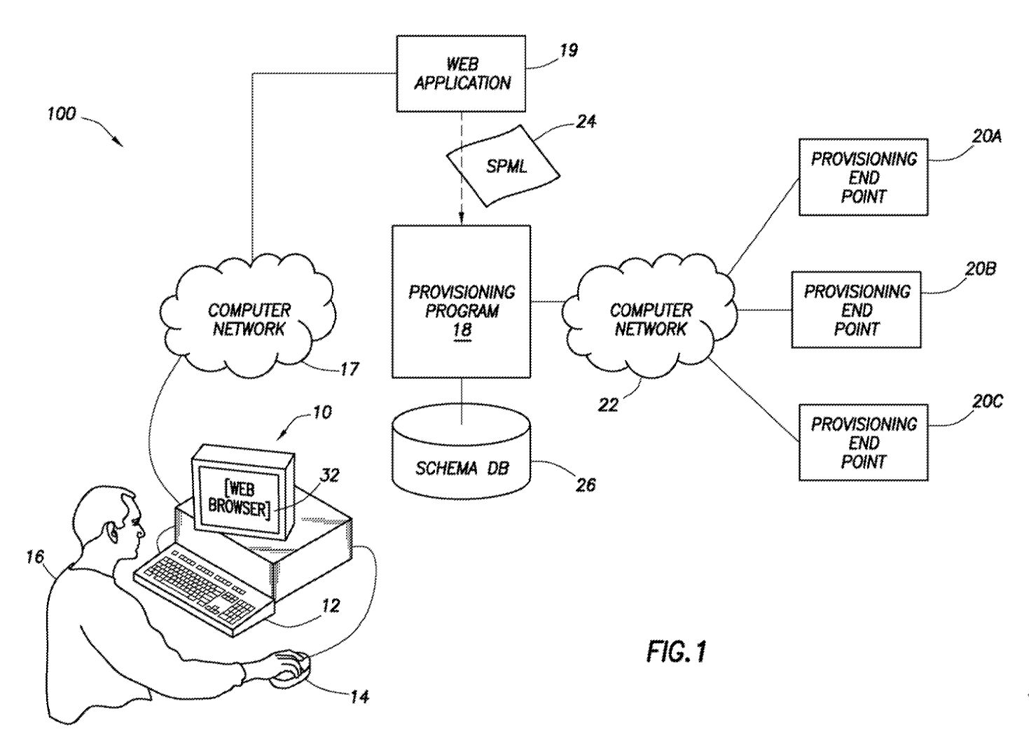

The various embodiments are directed to discovering a catalog of services of a provisioning program, choosing a service, and selecting and utilizing actions associated with the chosen service. FIG. 1 illustrates a provisioning system 100 in accordance with at least some embodiments. In particular, the system 100 comprises a computer system 10 with various input/output devices, such as a keyboard 12 and pointing device or mouse 14. A user 16 (e.g., a human resources employee) interacts with the computer system 10 by way of the input/output devices 12 and 14. The computer system 10 is coupled to a provisioning program 18, and in some embodiments the coupling is by way of computer network 17 and web application 19. The provisioning program 18, in turn, is coupled to a plurality of provisioning end points 20, and in some embodiments the coupling is by way of computer network 22.

Each provisioning end point 20 is used by a particular client, such as an employee (the client/employee not necessarily user 16). For example, a provisioning end point 20 may be an electronic mail program that provides electronic mail services to a client. A provisioning end point 20 may be a directory server where a client stores and retrieves files. A provisioning end point 20 may be a database that a client accesses to perform various tasks. Further still, the provisioning end points 20 need not be directly used by the client. For example, a provisioning end point 20 may be a payroll program to which a client/employee does not have access, but which ensures the employee is periodically provided a paycheck, or that that employee's salary is electronically transferred to a predetermined account. Each of these illustrative provisioning end points 20 use particular information to set up the various accounts and access privileges for the client. While only three provisioning end points 20 are shown, any number of provisioning end points may be used. Moreover, the three separate blocks for the provisioning end points 20 should not be construed to imply that the provisioning end points are on separate computer systems. While in some cases each provisioning end point 20 may be a program on a separate computer system, in other cases a single computer system (e.g., a server) may host a plurality of provisioning end points 20.

Still referring to FIG. 1, the provisioning program 18 couples to the provisioning end points 20 and is configured to interact with each provisioning end point 20 to add, modify or delete a client (e.g., user or employee). Consider, as an example, that a new employee accepts employment with a company, and that the employee is to be added to the company's payroll system, the employee is to have an electronic mail account, the employee is to have access to a particular directory server, and the employee is to have access to a database of customer information. In accordance with the various embodiments, the provisioning program is provided information regarding the new employee and the various systems that are affected by the presence of new employee. Once provided information on the new employee, and for this particular example, the provisioning program 18 then autonomously interacts with the company's payroll system (a provisioning end point) to add the new employee and set the employee's pay rate and frequency. The provisioning program 18 interacts with electronic mail program (a provisioning end point) to set up the electronic mail account. The provisioning program 18 interacts with the directory server program (e.g., lightweight directory access program (LDAP) server) (provisioning end point) to create a home directory and to set access permissions to other directories. Finally, the provisioning program 18 interacts with a database program (provisioning end point) to authorize access to, and possibly change permission on, the database. While in some cases the provisioning program 18 is executed on a separate computer system from the provisioning end points 20, in other embodiments a single computer system (e.g., a server) may host the provisioning program 18 as well as one or more of the provisioning end points 20.

Through the computer system 10, and possibly over the computer network 17, the user 16 interacts with the provisioning program 18. For example, the computer system 10 may implement a web browser 32 (e.g., Internet Explorer®, Firefox®). The web browser 32, interacting through the web application 19, enables the user 16 to remotely access the provisioning program 18. The web application 19 may be executed on the same computer system as the provisioning program 18, or on a different computer system communicatively coupled to the computer system on which the provisioning program 18 executes. In other embodiments, the computer system 10 may implement remote desktop program (e.g., Citrix ICA®), and thus the user may interact directly with the user interface of the provisioning program 18.

The provisioning program 18 performs the provisioning based on information provided to the provisioning program 18 from the user 16 (e.g., human resources employee). In some embodiments the provisioning program 18 is provided the information from the computer system 10 as an electronic form 24 coded in Service Provisioning Markup Language (SPML). SPML is a markup language particularly designed for provisioning services, and is based on Extensible Markup Language (XML). However, any suitable coding system may be equivalently used. Using the example above of a new employee, the electronic form 24 contains the information to provision the new employee into the company. The specification now turns to various mechanisms for the user 16 to discover services provided by the provisioning program, to choose particular services, and to select actions of those services and create the electronic form 24.

A provisioning program 18, in accordance with the various embodiments, implements or is otherwise coupled to a schema database (DB) 26. The various actions the provisioning program 18 provides (on one ore more provisioning end points) are logically grouped into “services,” and thus each service is a classification of for one or more related actions. All the services (and the actions for each service) are identified in one or more electronic documents stored in the schema database 26. Rather than providing predetermined forms containing information or lists of provisioning end points, each time a user 16 desires to activate the provisioning program 18 to perform provisioning with respect to the one or more provisioning end-points, the user 16 first requests a copy of a service catalog that defines at least some, and in some cases all, the services the provisioning program 18 provides. In some embodiments, the request is by way of an electronic document coded in SPML. In particular, in embodiments that communicate by way of SPML-based documents, the user 16 makes a request (in SPML terminology, the Requesting Authority (RA)) for the service catalog (in SPML terminology, a request for “targets” without target identification, thus retrieving all targets). The request for the service catalog is provided to the provisioning program 18 (in SPML terminology, the Provisioning Service Provider (PSP)).

In the related art, a SPML-based request for targets reveals to the requester the provisioning end points 20 (in SPML terminology, all the provisioning service targets (PSTs)). Stated otherwise, in the related art each provisioning end point is considered a SPML “target,” and thus a request for targets without target identification reveals the provisioning end points 20. In accordance with the various embodiments, however, the provision end points 20 are abstracted (hidden) from the user. Each of the services (each service being a classification of actions) is a target, and thus a request for the service catalog (again in SPML terminology, a request for targets without target identification) reveals all the services of the provisioning program 18, while refraining from exposing the particular provisioning end points 20. By choosing one or more services from the service catalog, the user requests a copy of each corresponding schema for the service. The user selects one more actions of the service, and based on information in the schema regarding action(s) an electronic form is created to solicit information from the user 16 used in performing the actions.

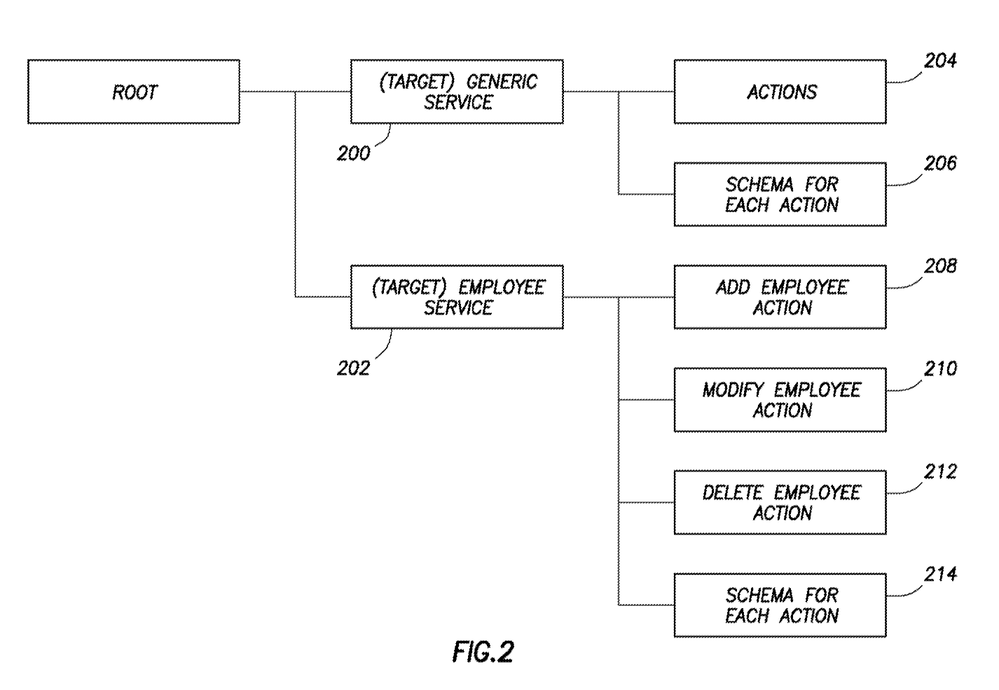

FIG. 2 illustrates in graphical form an exemplary XML document stored in the schema database 26. In particular, the document is organized, at least in part, under SPML, and defines an illustrative two targets 200 and 202. Rather than defining the targets as provisioning service targets as in the related art, in accordance with the various embodiments the targets are services, such as the illustrative generic service 200, or the more specific illustration of employee service 202. Two listed services are merely illustrative, and any number of services may be listed as targets in accordance with the various embodiments. Each service 200 and 202 is associated with one or more actions, and schemas for each action. In the case of the generic service 200, there may be one or more actions 204 associated with the service, and for each action there is a schema 206. Although each service 200 and 202 in the illustration of FIG. 2 has associated actions, an illustrative list of actions for only the employee service 202 is shown. In particular, the illustrative actions add employee action 208, modify employee action 210 and delete employee action 212 are associated with the employee service 202. The actions 208, 210 and 212 graphically shown in FIG. 2 may be defined in the associated schema 214.

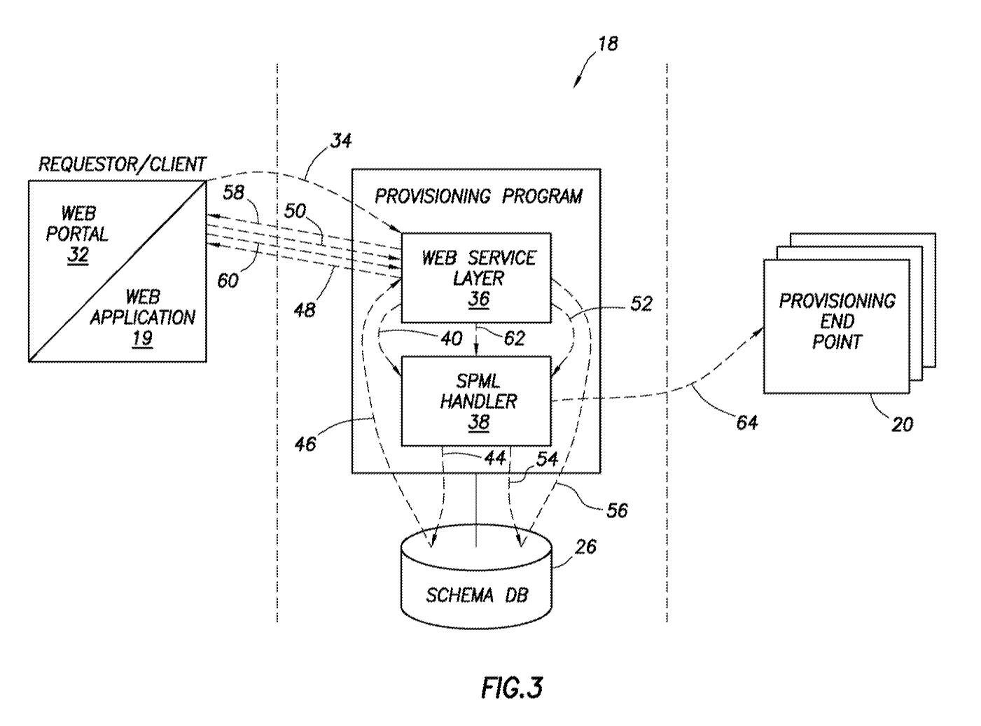

FIG. 3 illustrates a system in accordance with at least some embodiments. FIG. 3 is a simplified version of FIG. 1 in the sense that some of the components of FIG. 1 are omitted for clarity of the figure. FIG. 3 is, in another sense, more detailed than FIG. 1 as FIG. 3 shows some of the internal components of the provisioning program 18, as well as the interactions between a user and the provisioning program 18 in accordance with at least some embodiments. In particular, FIG. 3 illustrates a requestor/client which interacts with a provisioning program 18 by way of a web browser 32 and web application 19. The provisioning program 18, in turn and on behalf of the requestor/client, interacts with provisioning end points 20.

Referring simultaneously to FIGS. 2 and 3, for each particular provisioning request, and in accordance with at least some embodiments, a first action is to request a copy of the service catalog (as illustrated by dashed line 34). In situations where SPML is used as between the web application 19 and the provisioning program 18, the request for the service catalog is a request by the requestor/client (as the requesting authority) for “targets” without using a target identification, and with the request being exchanged by way of a Simple Object Access Protocol (SOAP) application layer protocol message. However, other markup languages for the request, and other message transport protocols, may be equivalently used.

The request for the service catalog is received by the web service layer 36. In situations where SPML messages are exchanged using a SOAP application layer protocol messages, the web service layer 36 may be a SOAP servlet. However, the web service layer may alternatively be configured for any message coding format and any message transport protocol. Further, the web service layer may also perform security related functions, such as ensuring the requestor/client on the web application 32 has permission to access the provisioning program 18. The web service layer may then pass the request for the service catalog to the SPML handler 38, with the passing of the request for the service catalog illustrated by dashed line 40.

Based on the request for the service catalog, the provisioning program 18, particularly the illustrative SPML hander 38, queries schema database 26 for the requested information, the query identified by dashed line 44. The service catalog information is provided to the web service layer 36 (as illustrated by dashed line 46), and the web service layer 36 passes the service catalog to the web application 19 (as illustrated by dashed line 48). In situations where SPML messages are exchanged as between the web application 19 and the provisioning program 18, returning of the service catalog by the provisioning program 18 is the return of a list of all targets 200, 202 and 204 which, in the various embodiments, are services. Moreover, the service catalog (list of targets) may be exchanged by way of SOAP application layer protocol message, but other markup languages for the request, and other message transport protocols, may be equivalently used.

The web application 19 formats the information for viewing on the web browser 32, and the user views the service catalog and chooses one or more services. In the illustrative case of FIG. 2, the service chosen may be the illustrative generic service 200 or the employee service 202. Based on the selection of one or more services, a request is made for schemas associated with each selected service, as illustrated by dashed line 50. In situations where SPML is used as between the web application 19 and the provisioning program 18, the request for the schema(s) is a request by the requestor/client (as the requesting authority) for “targets” with a particular identification, and with the request being exchanged by way of a Simple Object Access Protocol (SOAP) application layer protocol message. However, other markup languages for the request, and other message transport protocols, may be equivalently used.

The web service layer 36 receives the request for the schema(s), and passes the request to the SPML handler 38 (as illustrated by dashed line 52). The handler 38 reads the underlying message, and establishing that the message is a request for schema(s), the SPML hander 38 accesses the schema database 26 (as shown by dashed line 54), and sends a copy of the schema(s) to the web application 19 by way of the web service layer 36 (dashed lines 56 and 58). In situations where SPML messages are exchanged as between the web application 32 and the provisioning program 18, returning of the schema(s) by the provisioning program 18 is the return of the schema(s) 206, 208 and/or 210 associated with the selected services (targets). Moreover, the schema(s) may be exchanged by way of SOAP application layer protocol message, but other markup languages for the request, and other message transport protocols, may be equivalently used.

The web application 19 formats the information for viewing on the web browser 32, and enables the user to select one or more actions associated with the selected schema(s). For purposes of illustration, consider that the user through the web browser 32 and web application 19 selected the employee service 204, and from the schema 210 the three illustrative actions associated with the employee service 204 are identified: namely, add employee action 208, modify employee action 210 and delete employee action 212. The user, again through the web browser 32 and web application 19, selects one or more of the actions, and based on the selection and information contained in schema 210, the web application 19 generates a form that solicits information that the provisioning program 18 will use to perform the actions. Once the electronic form is completed, the web application 19 sends the electronic form to the provisioning program 18 (as illustrated by dashed line 60). Here again, the electronic document that contains the information supplied by the user may be coded in SPML, and provided to the provisioning program by way of SOAP application layer protocol message, but other markup languages, and other message transport protocols, may be equivalently used.

Once received by provisioning program 18, particularly the web service layer 36, the electronic file is passed to the SPML handler 38 (as illustrated by dashed line 62). The SPML handler parses the file, and based on the information therein performs various actions on the provisioning end points 20 (as illustrated by dashed line 64). The communication protocols between the provisioning program 18 and the provisioning end points 20 may be different depending on the particular provisioning end point 20. For example, in some cases a lightweight directory access protocol (LDAP) connection may be made to perform the provisioning. In other cases, one or more Unix SSH connectors may be established between the provisioning program 18 and one or more provisioning end points 20.

In some cases, information may be returned to the user through the web browser 32 and web application 19 (e.g., an indication of success, new passwords, assigned account names), and in these cases the information is returned in a fashion similar to delivery of the schema. The return of information after provisioning is not shown so as not to unduly complicate the figure.

Now consider that, after the first provisioning request, the user of the web browser 32 and web application 19 has a second provisioning request. In accordance with the various embodiments, each time provisioning is desired by the user, the user requests the service catalog, chooses a service, and then requests the schema for the service that identifies the actions associated with the service. In this way, if changes are made to the type, number or status of the provisioning end points 20, the changes are reflected in the schema(s) and user need not be concerned with the actual identities of the provisioning end points 20. Thus, a second provisioning request takes places in substantially the same manner as the first provisioning request.

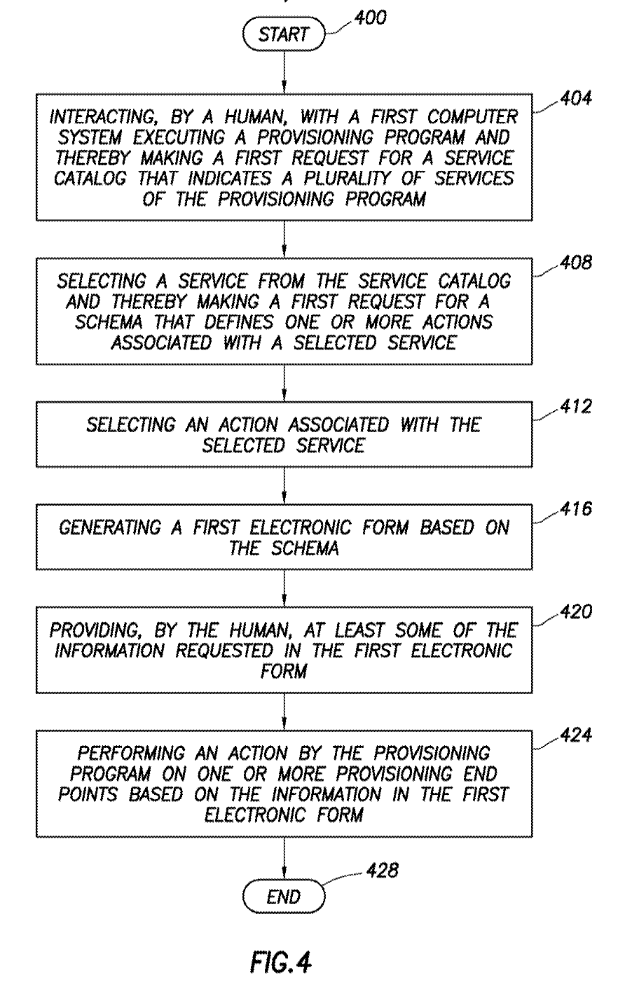

FIG. 4 illustrates method in accordance with at least some embodiments. In particular, the method starts (block 400) and proceeds to interacting, by a human, with a first computer system executing a provisioning program and thereby making a first request for a service catalog that indicates a plurality of services of the provisioning program (block 404). Next, a service is selected from the service catalog, and the selection thereby makes a first request for a schema associated with a selected service (block 408). Based on the schema received for the selected service, an action associated with the selected service is selected (block 412). An electronic form is generated based on the schema and the selected action (block 416). The human operator then provides at least some of the information requested in the electronic form (block 420). Finally, an action is performed by the provisioning program on one or more provisioning end points based on the information in the first electronic form (block 424), and the method ends (block 428).

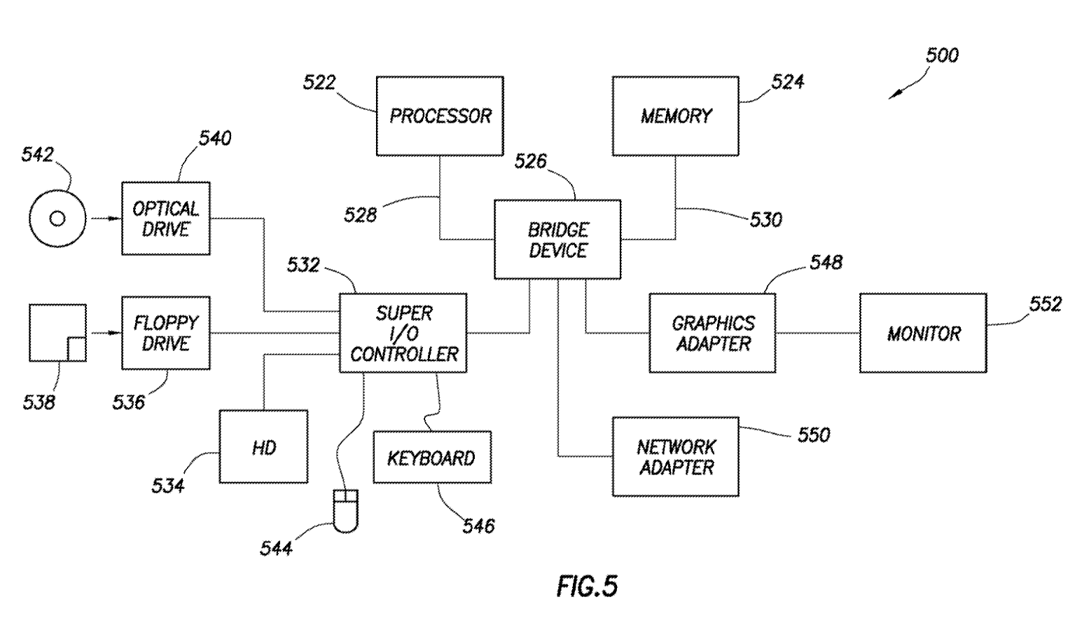

FIG. 5 illustrates a computer system 500. In particular, the computer system 500 comprises a processor 522 coupled to a memory device 524 by way of a bridge device 526. Although only one processor 522 is shown, multiple processor systems, and systems where the “processor” has multiple processing cores, may be equivalently implemented. The processor 522 couples to the bridge device 526 by way of a processor bus 528 and the memory 524 couples to the bridge device 528 by way of a memory bus 530. Memory 524 is any volatile or non-volatile memory device, or array of memory devices, such as random access memory (RAM) devices, dynamic RAM (DRAM) devices, static DRAM (SDRAM) devices, double data rate DRAM (DDR DRAM) devices, or magnetic RAM (MRAM) devices.

The bridge device 526 comprises a memory controller that asserts control signals for reading and writing the memory 524, the reading and writing both by processor 522 and by other devices coupled to the bridge device 526 (i.e., direct memory access (DMA)). The memory 524 is the working memory for the processor 522, which stores programs executed by the processor 522 and which stores data structures used by the programs executed on the processor 522. In some cases, the programs held in memory 524 are copied from other devices (e.g., hard drive 534, discussed below) prior to execution.

Bridge device 526 not only bridges the processor 522 to the memory 524, but also bridges the processor 522 and memory 524 to other devices. For example, illustrative computer system 400 comprises a super input/output (I/O) controller 532 which interfaces various I/O devices to the computer system. In the illustrative computer system 500, the super I/O controller 532 enables coupling and use of non-volatile memory devices such as a hard drive (HD) 534, “floppy” drive 536 (and corresponding “floppy” disk 538), and optical drive 540 (and corresponding optical disk 542 (e.g., compact disc (CD), digital versatile disc (DVD)), a pointing device or mouse 544, and a keyboard 546. The super I/O controller 532 may also enable use of other device not specifically shown, and is referred to as “super” because of the many I/O devices for which it enables use.

Still referring to FIG. 5, the bridge device 526 further bridges the processor 522 and memory 524 to other devices, such as a graphics adapter 548 and network adapter 550. Graphics adapter 548, if present, is any suitable graphics adapter for reading display memory and driving a monitor 552 with the graphics images represented in the display memory. In some embodiments, the graphics adapter 548 internally comprises a memory area to which graphics primitives are written by the processor 522 and/or by way of DMA writes between the memory 524 and the graphics adapter 548. The graphics adapter 548 couples to the bridge device by way of any suitable bus system, such as peripheral components interconnect (PCI) bus or an advanced graphics port (AGP) bus. In some embodiments, the graphics adapter 548 is integral with the bridge device 526.

Network adapter 550 enables the computer system 500 to communicate with other computer systems over a computer network. In some embodiments, the network adapter 550 provides access to a local area network (LAN) or wide area network (WAN) by way of hardwired connection (e.g., Ethernet network), and in other embodiments the network adapter 550 provides access to the LAN or WAN through a wireless networking protocol (e.g., IEEE 802.11(b), (g)). In yet still other embodiments, the network adapter 550 provides access to the Internet through a wireless broadband connection, such as a cellular-based wireless broadband Internet connection.

Illustrative computer system 500 may be the computer 10 through which the user 16 interacts with the provisioning program. Illustrative computer system 500 may also be the computer system on which the provisioning program 18 executes (and, in this case, may or may not be the computer with which the user 16 interacts with the provisioning program 18). Moreover, programs implemented and executed to perform the illustrative methods discussed above may be stored and/or executed from any of the computer-readable storage mediums of illustrative computer system 500 (e.g., memory 524, optical device 542, “floppy” drive 538 or hard drive 534).

From the description provided herein, those skilled in the art are readily able to combine software created as described with appropriate general-purpose or special-purpose computer hardware to create a computer system and/or computer subcomponents in accordance with the various embodiments, to create a computer system and/or computer subcomponents for carrying out the methods of the various embodiments, and/or to create a computer-readable storage media or mediums for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, the various exemplary embodiments are discussed in terms of employee provisioning; however, provisioning extends beyond just employee provisioning, and thus the various embodiments should not be construed to be limited to employee provisioning. For example, a business may provide a host of services to is customers (e.g., a bank), and it may be that the customers (interacting through the web application) set up, change and terminate services provided by the business (e.g., online banking features) through the web application. It is intended that the following claims be interpreted to embrace all such variations and modifications.

What is claimed is:

1. A method comprising:
interacting, by a human, with a first computer system executing a provisioning program and thereby making a first request for a service catalog that indicates a plurality of services of the provisioning program;
selecting a service from the service catalog and thereby making a first request for a schema that defines one or more actions associated with a selected service;
selecting an action associated with the selected service;
generating a first electronic form based on the schema;
providing, by the human, at least some of the information requested in the first electronic form; and
performing an action by the provisioning program on one or more provisioning end points based on the information in the first electronic form.

2. The method of claim 1 wherein the making the request for the service catalog further comprises making a Service Provisioning Markup Language request for targets.

3. The method of claim 1 wherein interacting further comprises interacting with the first computer system through a browser program executed on a second computer system remotely coupled to the first computer system.

4. The method of claim 2 wherein generating further comprises generating the first electronic form by the second computer system based on the schema.

5. The method of claim 1 further comprising:
interacting, by the human operator, with the first computer system and thereby making a second request for a service catalog that indicates a plurality of services of the provisioning program;
selecting a service from the service catalog and thereby making a second request for a schema that defines one or more actions associated with a selected service;
generating a second electronic form based on, and after receiving, the schema in response to the second request for the schema;
providing, by the human operator, information requested in the second form regarding a second provisioning request;
performing an action by the provisioning program on the one or more provisioning end points based on the information in the second electronic form.

6. The method of claim 5 further comprising:
wherein interacting and thereby making the second request further comprises interacting with first computer system through a browser program executed on a second computer system remotely coupled to the first computer system; and
wherein generating further comprises generating the second electronic form by the second computer system.

7. The method of claim 1 further comprising sending the first electronic form coded in Service Provisioning Markup Language.

8. A computer-readable storage medium storing a program that, when executed by a processor, causes the processor to:
make a request for a service catalog that defines a plurality of services a provisioning program is configured to perform;
request a first schema being a schema for at least one service selected by a user;
receive the first schema that defines, at least in part, information used by a provisioning program to perform provisioning with respect to one or more provisioning end points;
generate a first electronic form based on, and after receiving, the first schema;
receive information requested in the first electronic form regarding a first provisioning request; and
send the information to the provisioning program.

9. The computer-readable storage media of claim 8 further comprising:
when the processor makes the first request for the schema, the program causes the processor to request from a first computer system remotely coupled to the processor;
when the processor receives, the program further causes the processor to receive from the first computer system.

10. The computer-readable storage media of claim 8 wherein the program further causes the processor to:
make a second request for the service catalog;
request a second schema being a schema for at least one service selected by the user in the second;
receive the second schema;
generate a second electronic form based on, and after receiving, the second schema;
receive the information in a second electronic form regarding a second provisioning request from a user; and
send the information to the provisioning program.

11. A computer-readable storage media storing a program that, when executed by a processor, causes the processor to:
receive a request from a client program for a service catalog that defines, at least in part, services a provisioning program is configured to perform with respect to one or more target programs, and send the service catalog to the client program;
receive a request from the client program for a schema associated with a selected service, and send the schema to the client program;
receive an electronic form regarding a first provisioning request, the electronic form comprising data; and
perform provisioning of one or more provisioning end points based on the data.

12. The computer-readable storage media of claim 11 further comprising:
when the processor receives, the program further causes the processor to receive the request from the client program operating on a processor remotely coupled to the processor on which the program executes; and
when the processor sends, the program further causes the processor to send the schema to the client program executed on the processor remotely coupled to the processor on which the program executes.

13. The computer-readable storage media of claim 11 wherein when the processor obtains, the program causes the processor to obtain the schema from at least one selected from the group consisting of: a provisioning program coupled to the processor; and a copy of the schema stored locally to the processor.
